(19) United States
(12) Patent Application Publication
(10) Pub. No.: US 2008/0015886 A1
(43) Pub. Date: Jan. 17, 2008

(54) User Authentication System For Shopping Cart And Method Thereof

(75) Inventors: Yong-Sun Kim, Kyungki-do (KR); Jin-Kyeong Kim, Daejeon-city (KR); Woo-Yong Lee, Daejeon-city (KR)

Correspondence Address: LAHIVE & COCKFIELD, LLP, ONE POST OFFICE SQUARE, BOSTON, MA, 02109-2127, US

(73) Assignee: Electronics and Telecommunications Research Institute, Daejeon (KR)

(21) Appl. No.: 11/791,813

(22) PCT Filed: Dec. 16, 2004
(86) PCT No.: PCT/KR04/03315

§ 371 Date: May 29, 2007

(30) Foreign Application Priority Data
Nov. 29, 2004 (KR) 10-2004-0098641

(51) Int. Cl. G06Q 99/00; G06F 17/30

(52) U.S. Cl. 705/1

(57) ABSTRACT

A shopping cart user authentication system and control-method, by which authentication for use of the shopping cart is performed by using a user authentication card, are provided. The control-method includes: if a user authentication card is recognized, accessing an authentication server and requesting authentication of the user authentication card, and releasing a cart connection link so that the shopping cart can be used if authentication is successful; and if the cart connection link is connected to another shopping cart connection link, requesting that the authentication server release user authentication and return the user authentication card to complete returning of the shopping cart.

### TECHNICAL FIELD

The present invention relates to a user authentication system for a shopping cart, and more particularly, to a shopping cart user authentication system and method for performing shopping cart user authentication using a user authentication card.

### BACKGROUND ART

Generally, in large shopping centers, a shopper comes in, takes a cart which is set out in advance, places goods to be purchased in the cart while shopping, pays for the goods at a check-out counter, and then returns the cart.

The conventional shopping cart is designed so that if a coin is placed into a connection link of a connected shopping cart, the first shopping cart can be separated and used. In this shopping cart management system, the risk of losing carts by theft is high, and thus overhead is high. In addition, if a radio frequency identification (RFID) system or some other system is used in shopping carts in the future, increasing their functionality, sophistication, and value, it will become even more important to prevent them from getting stolen. In this regard, the conventional shopping cart management system is insufficient.

### BRIEF DESCRIPTION OF THE DRAWINGS

FIG. 1 is a block diagram of a shopping cart user authentication system according to the present invention;

FIG. 2 is a flowchart of control operations performed when a shopping cart is withdrawn for use in a shopping cart user authentication system according to the present invention; and

FIG. 3 is a flowchart of control operations performed when a shopping cart is returned in a shopping cart user authentication system according to the present invention.

### DETAILED DESCRIPTION OF THE INVENTION

Technical Goal of the Invention

The present invention provides a shopping cart user authentication system capable of preventing theft and reducing overhead cost by performing shopping cart user authentication using a user authentication card.

The present invention also provides a method for controlling the shopping cart user authentication system.

Effect of the Invention

According to the present invention as described above, by making only authenticated user use a shopping cart, theft of a shopping cart that becomes more intelligent, multi-functioned and expensive, can be prevented and the management cost of the shopping cart can be reduced. Also, being coupled with wireless communication such as a wireless LAN and a cellular network, the present invention helps to enable more convenient shopping and paying with receiving a variety of information such that a burden waiting at a counter can be reduced.

### BEST MODE FOR CARRYING OUT THE INVENTION

According to an aspect of the present invention, there is provided a shopping cart user authentication system including: a user recognition unit recognizing a user when a user authentication card is inserted therein or placed in contact therewith; a user authentication control unit performing a user authentication procedure with an authentication server using information read from the user authentication card, and releasing a connection link of the shopping cart and returning the user authentication card according to the result of the authentication procedure; and a communication unit communicating information read from the user authentication card and authentication information between the user authentication control unit and the user authentication server.

According to another aspect of the present invention, there is provided a shopping cart user authentication system control-method including: if a user authentication card is recognized, accessing an authentication server and requesting authentication of the user authentication card, and if authentication by the authentication server is successful, releasing a cart connection link so that the shopping cart can be used; and if the shopping cart connection link is reconnected to another shopping cart connection link, requesting that the authentication server release user authentication and return the user authentication card so that return of the shopping cart is complete.

The releasing of the cart connection link may include: recognizing the user when the user authentication card is inserted into or placed in contact with a user recognition unit; accessing the authentication server and requesting user authentication based on the user authentication card; confirming whether or not authentication by the authentication server is successful, generating an error message if authentication fails, and generating a cart connection link release message if authentication is successful.

Requesting the authentication server to release user authentication and return the user authentication card may include: requesting that the authentication server release user authentication if the user connects the connection link to another shopping cart; the user authentication server generating an answer to the request for release of user authentication; and confirming whether or not the user authentication card is inserted in a user recognition unit and returning the user authentication card if a user authentication release message is received from the user authentication server.

### EMBODIMENTS

The present invention will now be described more fully with reference to the accompanying drawings, in which exemplary embodiments of the invention are shown.

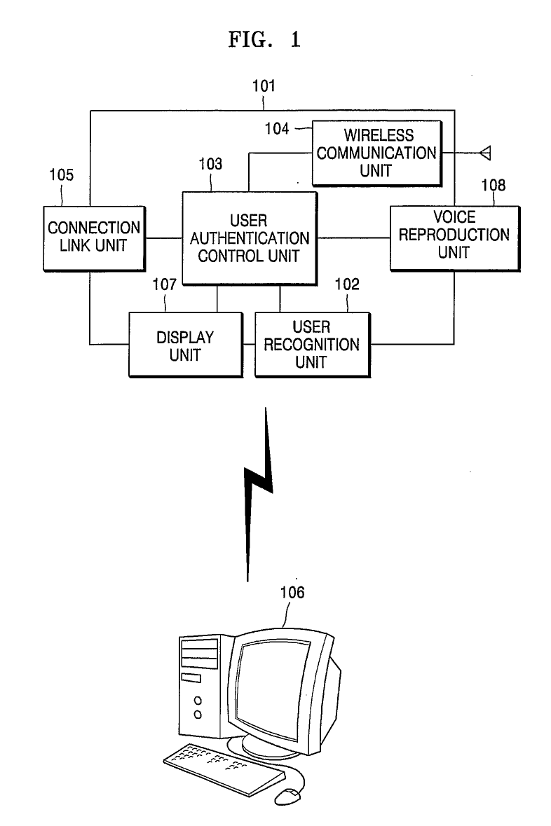

A shopping cart user authentication system, shown in FIG. 1, is formed of a user authentication apparatus 101 and a user authentication server 106.

The user authentication apparatus 101 is attached to a shopping cart, recognizes a user authentication card, performs a user authentication procedure or processes an authentication result received from the authentication server 106, and releases the connection link of the cart or returns the user authentication card.

The user authentication server 106 determines whether or not the user is a legal user by using user information received from the user authentication apparatus 101.

Here, the user authentication apparatus 101 is formed of a user recognition unit 102, a user authentication control unit 103, a wireless communication unit 104, a connection link unit 105, and a display unit 107.

If a user inserts a user authentication card into or places the user authentication card in contact with the user recognition unit 102, the user recognition unit 102 recognizes the user. Here, the user authentication card may be a credit card, a direct payment card, some other card that can be authenticated, or a mobile phone or mobile terminal that can be authenticated.

The user authentication control unit 103 reads user information of the card inserted into or brought into contact with the user recognition unit 102, processes the information into an appropriate format, requests the user authentication server 106 to approve or release the user information, and after receiving user authentication confirmation or release notice from the user authentication server 106, releases the cart connection link or returns the user authentication card.

The wireless communication unit 104 receives processed information from the user authentication control unit 103, transmits the information to the user authentication server 106, and provides user authentication information provided by the user authentication server 106 to the user authentication control unit 103. Here, as a communication means, the wireless communication unit 104 uses a wireless LAN, cellular communication, RFID communication, Bluetooth, mobile Internet, wideband code division multiple access (WCDMA), or 4G system.

The connection link unit 105 is connected to another shopping cart to prevent theft, and if user authentication is completed, the connection of the connection link unit 105 is released by a connection link release command of the user authentication control unit 103.

The display unit 107 displays a variety of messages generated in the user authentication control unit 103 as diagrams or characters.

The voice reproduction unit 108 reproduces a variety of messages generated in the user authentication control unit 103 as voice.

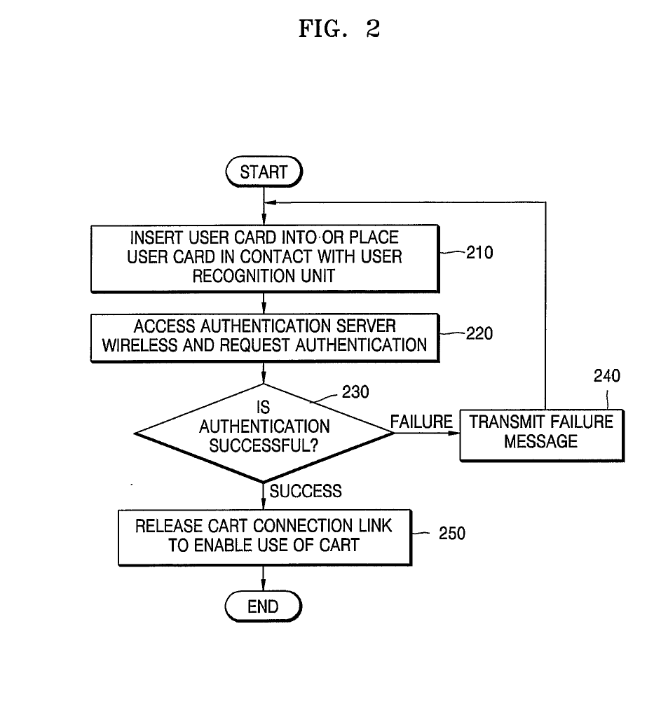

FIG. 2 is a flowchart of control operations performed when a shopping cart is used in a shopping cart user authentication system according to the present invention.

First, a user inserts a user authentication card into, or brings the user authentication card into contact with, the user recognition unit 102, in operation 210. The user authentication card may be a credit card, a direct payment card, an RFID card, a mobile phone, or a mobile terminal.

Then, the user authentication control unit 103 connects to the user authentication server 106 through the wireless communication unit 104, reads user information recorded on the card, transfers the user information, and requests authentication by the user authentication server 106, in operation 220.

Next, the user authentication server 106 determines whether or not the user information received through the wireless communication unit 104 is valid, through a predetermined authentication procedure, and transmits a message stating whether or not authentication is successful to the wireless communication unit 104, in operation 230.

Then, according to the message stating whether or not authentication is successful, received through the wireless communication unit 104, the user authentication control unit 103 determines whether to release the cart connection link in the event of successful authentication or to generate an error message in the event of authentication failure. That is, if an authentication success message is received, the user authentication control unit 103 releases the cart connection link to enable use of the cart in operation 250, and if an authentication failure message is received, the user 10 authentication control unit 103 transfers an error message to the display unit 107 or the voice reproduction unit 108 in operation 240.

In another embodiment, if authentication fails, the user authentication control unit 103 sends a control signal to a wheel control means of the shopping cart to disable operation of the wheels to prevent theft.

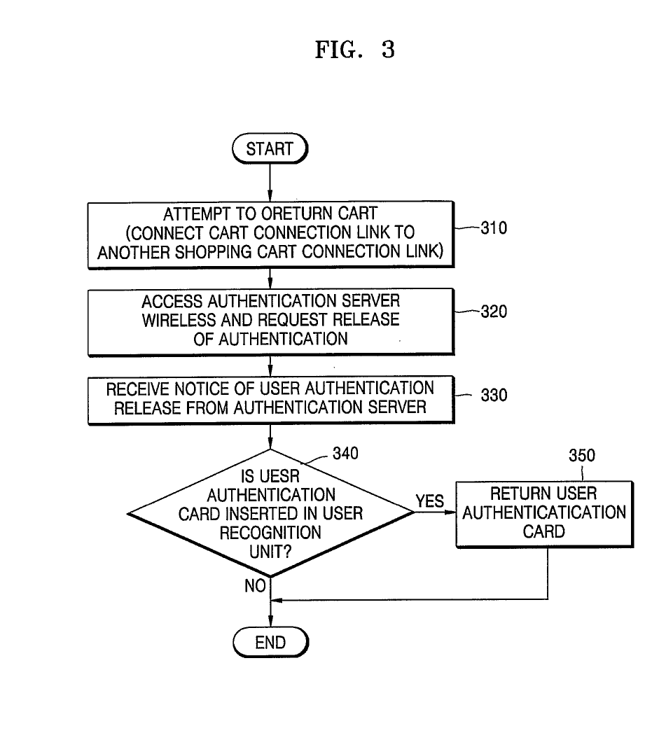

FIG. 3 is a flowchart of control operations performed when a shopping cart is returned in a shopping cart user authentication system according to the present invention.

First, if the user decides to stop using the cart and connects the cart connection link to that of another shopping cart in operation 310, the user authentication control unit 103 detects the state of the connection link by using, for example, a well-known sensor or the like.

Here, the use authentication control unit 103 accesses the user authentication server 106 through the wireless communication unit 104 and transmits a user authentication release request in operation 320.

If the user authentication card can be used to pay bills and the user wants to pay for goods loaded in the cart, the user may make a request to the user authentication server 106 to make payment before requesting authentication release. Here, since the user authentication server 106 is connected to an external network, it can transfer the response to the user's payment request to the user authentication apparatus 101.

If a user authentication release notice from the user authentication server 106 is received through the wireless communication unit 104 in operation 330, the user authentication control unit 103 indicates that user authentication release is completed on the display unit 107 or via the voice reproduction unit 108, and checks whether or not the user authentication card is inserted in the cart, in operation 340. At this time, if the user authentication card is inserted in the cart, the user authentication control unit 103 returns the user authentication card in operation 350.

If the user doesn't follow the user authentication release procedure, there is a possibility that the shopping cart is being stolen, so the user authentication control unit 103 transmits to the mobile phone of the user a predetermined alarm message that is generated when the user does not follow the user authentication release procedure.

While the present invention has been particularly shown and described with reference to exemplary embodiments thereof, it will be understood by those of ordinary skill in the art that various changes in form and details may be made herein without departing from the spirit and scope of the present invention as defined by the following claims. For example, one possible addition to the above disclosure within the scope of the claimed invention is that when a shopping cart is lost, the user authentication apparatus may add predetermined charges to the user's mobile phone bill or credit card bill.

The present invention can also be embodied as computer code recorded on a computer-readable recording medium. The computer-readable recording medium may be any data storage device that can store the computer code such that the computer code can be thereafter read by a computer. Examples of the computer-readable recording medium include read-only memory (ROM), random-access memory (RAM), CD-ROM, magnetic tapes, floppy disks, optical data storage devices, and carrier waves (such as data transmission over the Internet). The computer-readable recording medium can also be distributed among a network of coupled computer systems so that the computer code is stored and executed in a decentralized manner.

1. A shopping cart user authentication system comprising:
a user recognition unit recognizing a user when a user authentication card is inserted therein or placed in contact therewith;
a user authentication control unit performing a user authentication procedure with an authentication server using information read from the user authentication card recognized by the user recognition unit, and releasing a connection link of the shopping cart and returning the user authentication card according to the result of the authentication procedure; and
a communication unit communicating information read from the user authentication card and authentication information between the user authentication control unit and the user authentication server.

2. The system of claim 1, wherein the user authentication control unit makes a request to the user authentication server to authenticate the information recorded in the user authentication card inserted into the user recognition unit, if the connection link of the shopping cart is connected to another shopping cart, requests that the connection link be released, and controls release of the connection link of the cart and return of the user authentication card according to whether or not authentication is successful and a connection link release notice is received from the user authentication server.

3. The system of claim 1, wherein the communication unit is a wireless communication apparatus.

4. A shopping cart user authentication system control-method comprising:
if a user authentication card is recognized, accessing an authentication server and requesting authentication of the user authentication card, and if authentication by the authentication server is successful, releasing a cart connection link so that the shopping cart can be used; and
if the shopping cart connection link is reconnected to another shopping cart connection link, requesting that the authentication server release user authentication and return the user authentication card so that return of the shopping cart is complete.

5. The method of claim 4, wherein the releasing of the cart connection link comprises:
recognizing the user when the user authentication card is inserted into or placed in contact with a user recognition unit;
accessing the authentication server and requesting user authentication based on the user authentication card;
confirming whether or not authentication by the authentication server is successful, generating an error message if authentication fails, and generating a cart connection link release message if authentication is successful.

6. The method of claim 4, wherein requesting that the authentication server release user authentication and return the user authentication card comprises:
requesting that the authentication server release user authentication if the user connects the connection link to another shopping cart;
the user authentication server generating an answer to the request for release of user authentication; and
confirming whether or not the user authentication card is inserted in a user recognition unit and returning the user authentication card if a user authentication release message is received from the user authentication server.

7. The method of claim 6, further comprising:
displaying a user authentication release completion message if the user authentication release message is received from the user authentication server.

8. The method of claim 7, further comprising:
generating the user authentication release completion message as an audible voice message.

9. The method of claim 6, further comprising:
transmitting a predetermined warning to a user who does not perform the user authentication release procedure.
